(19) United States
(12) Patent Application Publication
(10) Pub. No.: US 2011/0246138 A1
(43) Pub. Date: Oct. 6, 2011

(54) HARDWARE STATUS DETECTING CIRCUIT FOR GENERATING ONE HARDWARE STATUS DETECTING SIGNAL HAVING INFORMATION OF MULTIPLE HARDWARE STATUS DETECTORS, RELATED HARDWARE STATUS IDENTIFYING CIRCUIT, RELATED HARDWARE STATUS DETECTING SYSTEM, AND RELATED METHODS

(76) Inventors: Yi-Jen Chung, Hsinchu County (TW); Chi-Pei Huang, Miaoli County (TW); Ching-Ning Chiu, Hsin-Chu Hsien (TW); Jin-Bin Yang, Hsinchu City (TW)

(21) Appl. No.: 12/912,732

(22) Filed: Oct. 26, 2010

Related U.S. Application Data
(60) Provisional application No. 61/319,886, filed on Apr. 1, 2010.

(51) Int. Cl. G06F 11/30; G06F 15/00

(52) U.S. Cl. 702/186

(57) ABSTRACT

A hardware status detecting circuit for detecting a hardware status of a target apparatus includes a plurality of hardware status detectors operating in response to the hardware status of the target apparatus, and a signal processing unit coupled to the hardware status detectors for generating a hardware status detecting signal having information of operational statuses of the hardware status detectors embedded therein.

### CROSS REFERENCE TO RELATED APPLICATIONS

This application claims the benefit of U.S. Provisional Application No. 61/319,886, filed on Apr. 1, 2010 and incorporated herein by reference.

### BACKGROUND

The disclosed embodiments of the present invention relate to detecting/identifying a hardware status of a target apparatus, and more particularly, to a hardware status detecting circuit for generating a hardware status detecting signal having information of operational statuses of a plurality of hardware status detectors embedded therein, a hardware identifying circuit for processing the hardware status detecting signal to identify a hardware status of a target apparatus, a related hardware status detecting system, and related methods.

In general, a controller chip of a hardware device needs to determine a hardware status of the hardware device to properly control the operation of the hardware device. Taking a slot-in type optical disc drive for example, the loading/unloading mechanism sucks in an inserted optical disc and guides the optical disc to be properly positioned inside the optical disc drive when the optical disc is disposed at the entrance of the optical disc drive or unloads the optical disc when a command of ejecting the inserted optical disc is triggered. Compared with the tray type optical disc drive, the slot-in type optical disc drive has no physical tray for loading and carrying the optical disc. Therefore, the hardware status (e.g., the optical disc loading/unloading status) of the slot-in type optical disc drive is detected through switches. For example, the on/off statuses of the switches can be used to determine that the slot-in type optical disc drive has no optical disc loaded therein, the slot-in type optical disc drive has an optical disc already loaded therein, the slot-in type optical disc drive has an optical disc which is currently moving due to disc loading/unloading and does not reach the final position yet, disc size of an optical disc loaded into the slot-in type optical disc drive, or the slot-in type optical disc drive leaves a standby/sleep mode due to a wake-up event such as insertion of an optical disc at the entrance of the slot-in type optical disc drive.

Regarding a conventional design of the controller chip of the slot-in type optical disc drive, the controller chip has a plurality of specific input/output (I/O) pins dedicated to receiving switch levels of the switches, respectively. In other words, the number of the specific I/O pins must be equal to the number of switches used for detecting the hardware status. As a result, it is difficult to reduce the pin count, the chip area, and the production cost of the conventional controller chip.

### SUMMARY

In accordance with exemplary embodiments of the present invention, a hardware status detecting circuit for generating a hardware status detecting signal having information of operational statuses of a plurality of hardware status detectors embedded therein, a hardware identifying circuit for processing the hardware status detecting signal to identify a hardware status of a target apparatus, a related hardware status detecting system, and related methods are proposed to solve the above-mentioned problem.

According to a first aspect of the present invention, an exemplary hardware status detecting circuit for detecting a hardware status of a target apparatus is disclosed. The exemplary hardware status detecting circuit includes: a plurality of hardware status detectors, operating in response to the hardware status of the target apparatus; and a signal processing unit, coupled to the hardware status detectors, for generating a hardware status detecting signal having information of operational statuses of the hardware status detectors embedded therein.

According to a second aspect of the present invention, an exemplary hardware status identifying circuit for identifying a hardware status of a target apparatus is disclosed. The exemplary hardware status identifying circuit includes: a signal processing logic, for receiving a first hardware status detecting signal and determining operational statuses of a plurality of first hardware status detectors by processing the first hardware status detecting signal; and a hardware status identifying logic, coupled to the signal processing logic, for identifying the hardware status of the target apparatus according to the determined operational statuses of the first hardware status detectors.

According to a third aspect of the present invention, an exemplary hardware status processing system is disclosed. The exemplary hardware status processing system includes a hardware status detecting circuit and a controller chip. The hardware status detecting circuit is for detecting a hardware status of a target apparatus, and includes a plurality of first hardware status detectors operating in response to the hardware status of the target apparatus, and a signal processing unit, coupled to the first hardware status detectors, for generating a first hardware status detecting signal having information of operational statuses of the first hardware status detectors embedded therein. The controller chip includes: a first pin, coupled to the hardware status detecting circuit, for receiving the first hardware status detecting signal; and a hardware status identifying circuit for identifying the hardware status of the target apparatus. The hardware status identifying circuit includes a signal processing logic, for determining the operational statuses of the first hardware status detectors by processing the first hardware status detecting signal, and a hardware status identifying logic, coupled to the signal processing logic, for identifying the hardware status of the target apparatus according to the operational statuses of the first hardware status detectors.

According to a fourth aspect of the present invention, an exemplary method for detecting a hardware status of a target apparatus is disclosed. The exemplary method includes the following steps: utilizing a plurality of hardware status detectors which operate in response to the hardware status of the target apparatus; and generating a hardware status detecting signal having information of operational statuses of the hardware status detectors embedded therein.

According to a fourth aspect of the present invention, an exemplary method for identifying a hardware status of a target apparatus is disclosed. The exemplary method includes the following steps: receiving a hardware status detecting signal, and determining operational statuses of a plurality of first hardware status detectors by processing the hardware status detecting signal; and identifying the hardware status of the target apparatus according to the determined operational statuses of the first hardware status detectors.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating a hardware status processing system according to a first exemplary embodiment of the present invention.

FIG. 2 is a first exemplary implementation of a hardware status detecting circuit shown in FIG. 1.

FIG. 3 is a diagram illustrating the exemplary mapping between combinations of on/off statuses of switches and voltage levels of a hardware status detecting signal.

FIG. 4 is a diagram illustrating one alternative design of the hardware status detecting circuit shown in FIG. 2.

FIG. 5 is a diagram illustrating another alternative design of the hardware status detecting circuit shown in FIG. 2.

FIG. 6 is a flowchart illustrating the operation of the hardware status detecting system in FIG. 1 with the hardware status detecting circuit implemented using one of the exemplary circuit configurations shown in FIG. 2, FIG. 4, and FIG. 5.

FIG. 7 is a second exemplary implementation of the hardware status detecting circuit shown in FIG. 1.

FIG. 8 is a flowchart illustrating the operation of the hardware status detecting system in FIG. 1 with the hardware status detecting circuit implemented using the exemplary circuit configuration shown in FIG. 7.

FIG. 9 is a third exemplary implementation of the hardware status detecting circuit shown in FIG. 1.

FIG. 10 is a flowchart illustrating the operation of the hardware status detecting system in FIG. 1 with the hardware status detecting circuit implemented using the exemplary circuit configuration shown in FIG. 9.

FIG. 11 is a flowchart illustrating the operation of a hardware status identifying circuit shown in FIG. 1.

FIG. 12 is a block diagram illustrating a hardware status processing system according to a second exemplary embodiment of the present invention.

FIG. 13 is a diagram illustrating an exemplary implementation of the hardware status detector shown in FIG. 12.

FIG. 14 is a flowchart illustrating the operation of a hardware status identifying circuit shown in FIG. 12.

FIG. 15 is a block diagram illustrating a hardware status processing system according to a third exemplary embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

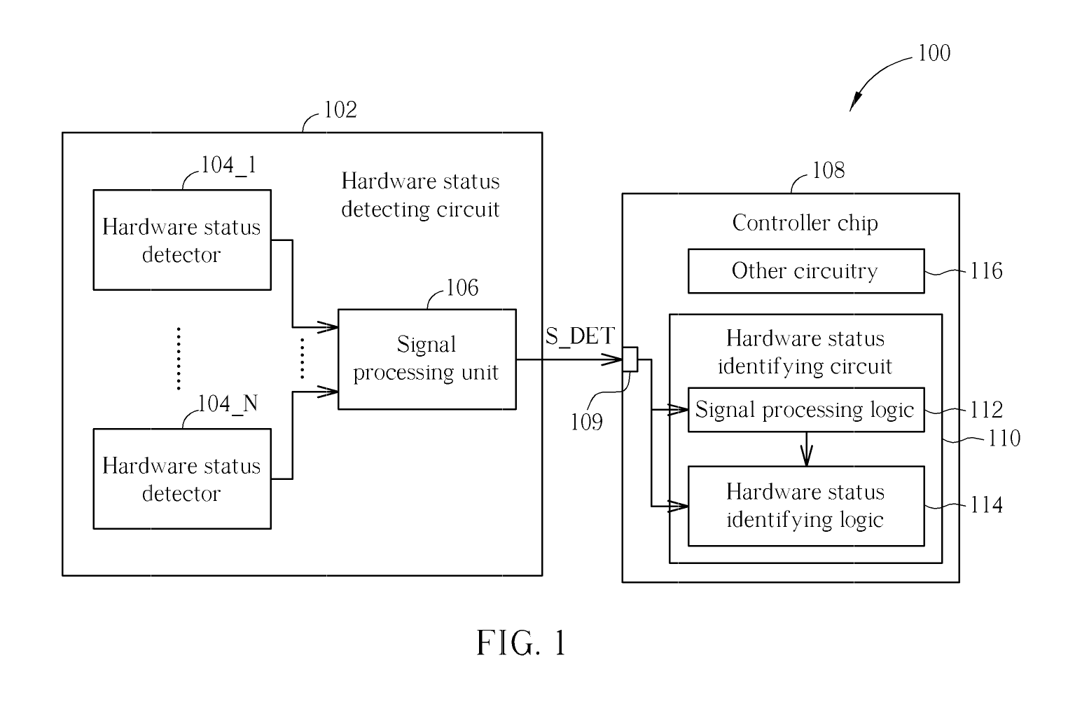

FIG. 1 is a block diagram illustrating a hardware status processing system according to a first exemplary embodiment of the present invention. The exemplary hardware status processing system 100 includes a hardware status detecting circuit 102 and a controller chip 108. The hardware status detecting circuit 102 is utilized for detecting a hardware status of a target apparatus. In this embodiment, the hardware status detecting circuit 102 includes a plurality of hardware status detectors 104_1-104_N and a signal processing unit 106. The hardware status detectors 104_1-104_N are arranged to operate in response to the hardware status of the target apparatus, and the signal processing unit 106 is coupled to the hardware status detectors 104_1-104_N and implemented for generating a hardware status detecting signal S_DET, wherein the hardware status detecting signal S_DET has information of operational statuses of the hardware status detectors 104_1-104_N embedded therein. By way of example, but not limitation, the controller chip 108 has a pin 109 for receiving the hardware status detecting signal S_DET generated from the hardware status detecting circuit 102.

As shown in FIG. 1, the controller chip 108 includes a hardware status identifying circuit 110 for identifying the hardware status of the target apparatus. In this exemplary embodiment, the hardware status identifying circuit 110 includes a signal processing logic 112 and a hardware status identifying logic 114. The signal processing logic 112 is used for determining the operational statuses of the hardware status detectors 104_1-104_N by processing the hardware status detecting signal S_DET. The hardware status identifying logic 114 is coupled to the signal processing logic 112 for identifying the hardware status of the target apparatus according to the determined operational statuses of the hardware status detectors 104_1-104_N. Moreover, under some specific situations (such as sleep mode or standby mode), the hardware status identifying logic 114 can identify the hardware status of the target apparatus by a level change of the hardware status detecting signal S_DET.

In addition, the controller chip 108 may include other circuitry 116 to perform additional functions. By way of example, but not limitation, a target apparatus may be an optical storage apparatus (e.g., a slot-in type optical disc drive) having the hardware status processing system 100 employed therein. However, this is for illustrative purposes only, and is not meant to be a limitation to the present invention. That is, any apparatus employing the exemplary hardware status processing system 100 for hardware status detection falls within the scope of the present invention.

As can be seen from FIG. 1, one hardware status detecting signal S_DET is generated and transmitted to inform the controller chip 108 of the information of operational statuses of multiple hardware status detectors 104_1-104_N. Though there are multiple hardware status detectors 104_1-104_N implemented, one pin 109 of the controller chip 108 is used. In this way, the pin count, the chip area, and the production cost of the controller chip 108 can be effectively reduced. Details of the hardware status detecting circuit 102 and the hardware status identifying circuit 110 are described as follows.

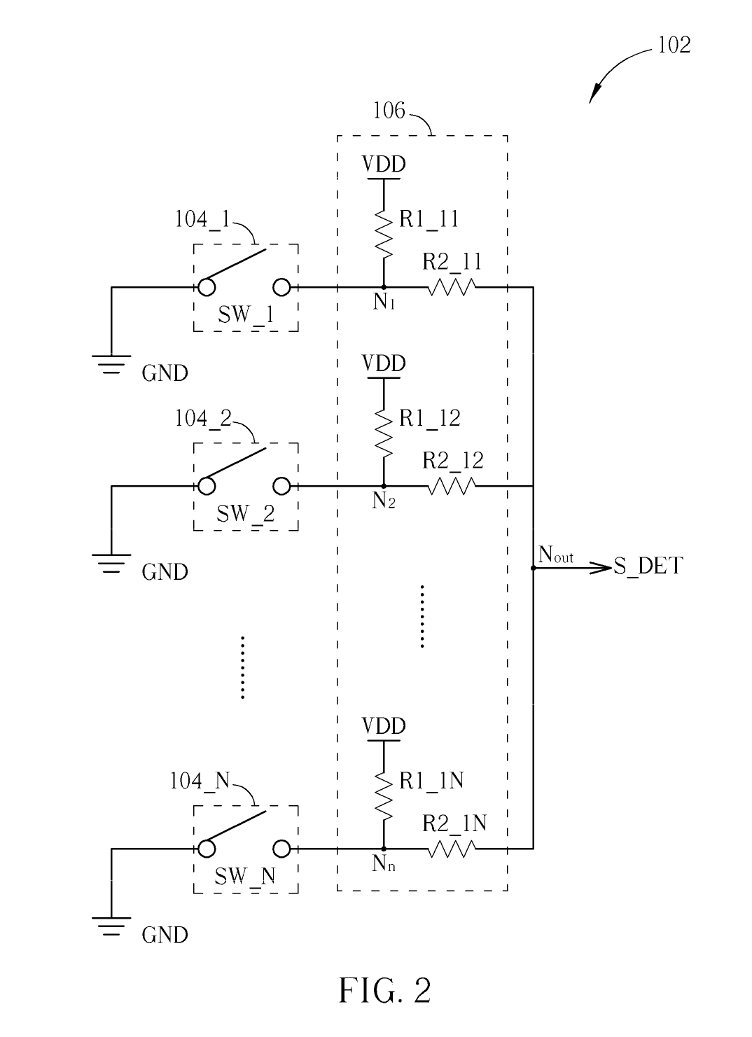

Please refer to FIG. 2, which is a first exemplary implementation of the hardware status detecting circuit 102 shown in FIG. 1. The signal processing unit 106 has a plurality of input nodes N₁-Nₙ and a single output node Nₒᵤₜ utilized for outputting the hardware status detecting signal S_DET. In addition, the hardware status detectors 104_1-104_N are implemented with switches SW_1-SW_N respectively coupled to the input nodes N₁-Nₙ. Specifically, each of the switches SW_1-SW_N is coupled between a first reference voltage (e.g., a ground voltage GND) and one of the input nodes N₁-Nₙ. Regarding the signal processing unit 106, it includes a plurality of first resistive elements R1_11-R1_1N respectively coupled to the input nodes N₁-Nₙ and a plurality of second resistive elements R2_11-R2_1N respectively coupled to the input nodes N₁-Nₙ. As can be seen from FIG. 2, each of the first resistive elements R1_11-R1_1N is coupled between a second reference voltage (e.g., a supply voltage VDD) and one of the input nodes N₁-Nₙ, and each of the second resistive elements R2_11-R2_1N is coupled between the single output node Nₒᵤₜ and one of the input nodes N₁-Nₙ. It should be noted that the resistive values of the first resistive elements R1_11-R1_1N and the second resistive elements R2_11-R2_1N should be properly designed such that the signal processing unit 106 is capable of setting a voltage level of the hardware status detecting signal S_DET to represent the information of the operational statuses of the hardware status detectors 104_1-104_N, where different voltage levels of the hardware status detecting signal S_DET correspond to different combinations of the operational statuses of the hardware status detectors 104_1-104_N, respectively.

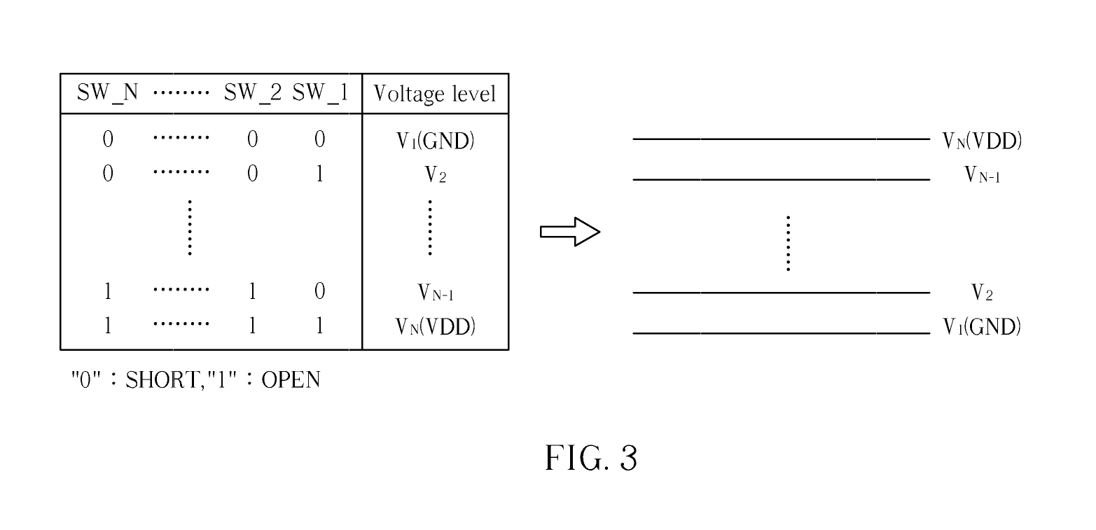

FIG. 3 is a diagram illustrating the exemplary mapping between combinations of the on/off statuses of the switches SW_1-SW_N (i.e., operational statuses of the hardware status detectors 104_1-104_N) and voltage levels of the hardware status detecting signal S_DET. With a proper design of the first resistive elements R1_11-R1_1N and the second resistive elements R2_11-R2_1N, a specific combination of the on/off statuses of the switches SW_1-SW_N can be particularly represented by a specific voltage level of the hardware status detecting signal S_DET. For example, in a case where a slot-in type optical disc drive has no optical disc loaded therein, all of the switches SW_1-SW_N may stay in the default status (e.g., “off” status), and the signal processing unit 106 shown in FIG. 2 sets the hardware status detecting signal S_DET to have a voltage level equal to V_{N} (VDD). In another case where the slot-in type optical disc drive has an optical disc already loaded therein, all of the switches SW_1-SW_N may be switched on due to the contact of the inserted optical disc, and the signal processing unit 106 shown in FIG. 2 therefore sets the hardware status detecting signal S_DET to have a voltage level equal to V₁ (GND). However, this is for illustrative purposes only. The mapping between the hardware status (e.g., the optical disc loading/unloading status) of the slot-in type optical disc drive and the combination of the on/off statues of the switches SW_1-SW_N may be adjusted according to the actual design consideration.

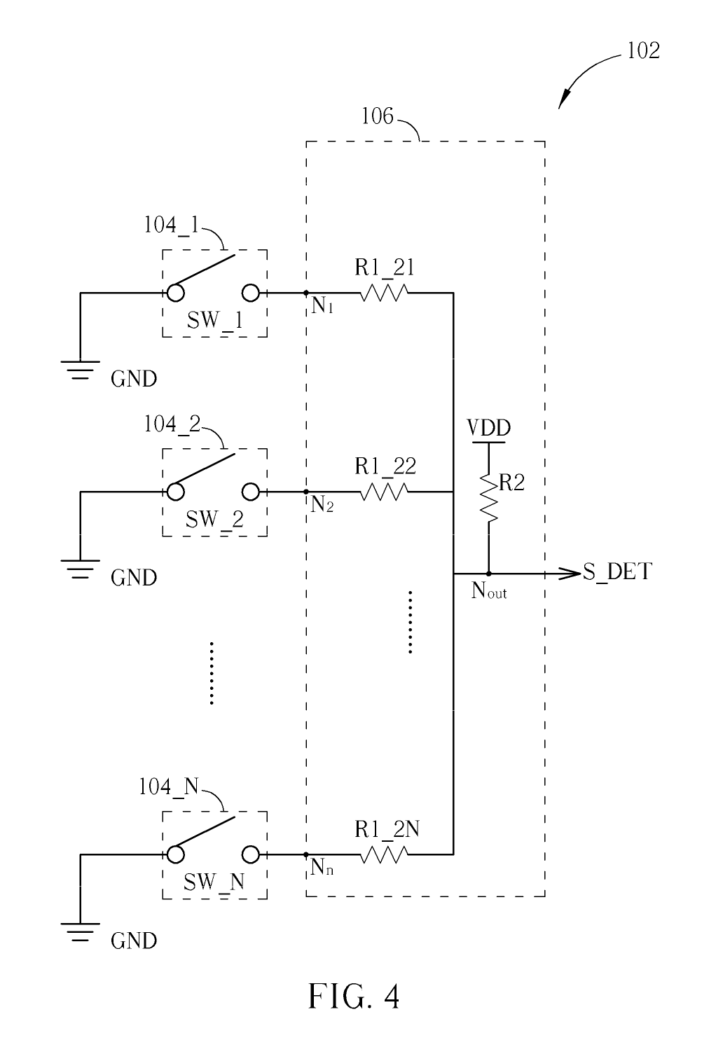

Please refer to FIG. 4, which is a diagram illustrating one alternative design of the hardware status detecting circuit 102 shown in FIG. 2. As shown in FIG. 4, the signal processing unit 106 has a plurality of input nodes N₁-Nₙ and a single output node Nₒᵤₜ utilized for outputting the hardware status detecting signal S_DET. Similarly, the hardware status detectors 104_1-104_N are implemented with switches SW_1-SW_N respectively coupled to the input nodes N₁-Nₙ, where each of the switches SW_1-SW_N is coupled between a first reference voltage (e.g., the ground voltage GND) and one of the input nodes N₁-Nₙ. In this exemplary embodiment, the signal processing unit 106 includes a plurality of first resistive elements R1_21-R1_2N respectively coupled to the input nodes N₁-Nₙ, and a second resistive element R2 coupled between the single output node Nₒᵤₜ and a second reference voltage (e.g., the supply voltage VDD). Specifically, each of the first resistive elements R1_21 is coupled between the single output node Nₒᵤₜ and one of the input nodes N₁-Nₙ. In addition, by properly setting the resistive values of the first resistive elements R1_21-R1_2N and the second resistive element R2, the signal processing unit 106 shown in FIG. 4 is also capable of setting a voltage level of the hardware status detecting signal S_DET to represent the information of the operational statuses of the hardware status detectors 104_1-104_N, where different voltage levels of the hardware status detecting signal S_DET respectively correspond to different combinations of the operational statuses of the hardware status detectors 104_1-104_N, as shown in FIG. 3.

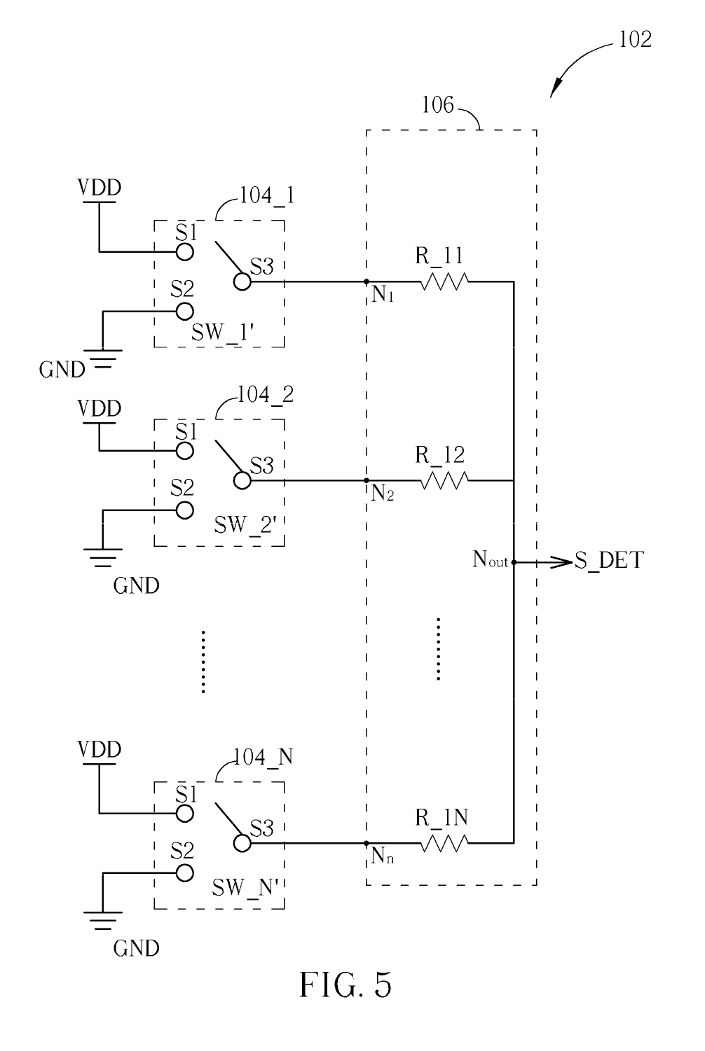

Please refer to FIG. 5, which is a diagram illustrating another alternative design of the hardware status detecting circuit 102 shown in FIG. 2. As shown in FIG. 5, the signal processing unit 106 has a plurality of input nodes N₁-Nₙ and a single output node Nₒᵤₜ utilized for outputting the hardware status detecting signal S_DET. In this exemplary embodiment, the hardware status detectors 104_1-104_N are implemented with switches SW_1′-SW_N′ respectively coupled to the input nodes N₁-Nₙ. Specifically, each of the switches SW_1′-SW_N′ has a first input end S1 coupled to a first reference voltage (e.g., the supply voltage VDD), a second input end S2 coupled to a second reference voltage (e.g., the ground voltage GND), and an output end S3 coupled to one of the input nodes N₁-Nₙ, where the output end S3 is selectively coupled to the first input end S1 or the second input end S2 according to an operational state of the switch. For example, the output end S3 is coupled to the first input end S1 under a default setting, and the output end S3 is coupled to the second input end S2 when the switch has a contact with an inserted optical disc.

In this exemplary embodiment, the signal processing unit 106 is simply implemented with a plurality of resistive elements R_11-R_1N respectively coupled to the input nodes N₁-Nₙ. Therefore, each of the resistive elements R_11-R_1N is coupled between the single output node Nₒᵤₜ and one of the input nodes N₁-Nₙ. Similarly, by properly setting the resistive values of the resistive elements R_11-R_1N, the signal processing unit 106 shown in FIG. 5 is also capable of setting a voltage level of the hardware status detecting signal S_DET to represent the information of the operational statuses of the hardware status detectors 104_1-104_N, where different voltage levels of the hardware status detecting signal S_DET respectively correspond to different combinations of the operational statuses of the hardware status detectors 104_1-104_N, as shown in FIG. 3.

Please note that the circuit configurations shown in FIG. 2, FIG. 4, and FIG. 5 are for illustrative purposes only. That is, the number of switches and the number of resistive elements may be adjusted according to actual design consideration. For example, two switches, two first resistive elements, and two second resistive elements may be used to realize the hardware status detecting circuit 102 shown in FIG. 2; two switches, two first resistive elements, and one second resistive element may be used to realize the hardware status detecting circuit 102 shown in FIG. 4; and two switches and two resistive elements may be used to realize the hardware status detecting circuit 102 shown in FIG. 5. These all fall within the scope of the present invention.

When the hardware status detecting circuit 102 is realized by one of the circuit configurations shown in FIG. 2, FIG. 4, and FIG. 5, the signal processing logic 112 is arranged to determine the operational statuses (or detector statuses) of the hardware status detectors 104_1-104_N (i.e., statuses of switches SW_1-SW_N/SW_1′-SW_N′) by checking a voltage level of the hardware status detecting signal S_DET. As different voltage levels of the hardware status detecting signal S_DET correspond to different combinations of the operational statuses of the hardware status detectors 104_1-104_N, respectively, the operational statuses of the hardware status detectors 104_1-104_N can be easily identified.

Considering a case where the hardware status detecting signal S_DET has a voltage level equal to V_{N} (VDD), the signal processing logic 112 determines that all of the switches SW_1-SW_N stay in the default status (e.g., “off” status) according to the exemplary mapping shown in FIG. 3, and the hardware status identifying logic 114 accordingly judges that the slot-in type optical disc drive has no optical disc loaded therein. Considering another case where the hardware status detecting signal S_DET has a voltage level equal to V₁ (GND), the signal processing logic 112 determines that all of the switches SW_1-SW_N are switched on according to the exemplary mapping shown in FIG. 3, and the hardware status identifying logic 114 accordingly judges that the slot-in type optical disc drive has an optical disc already loaded therein.

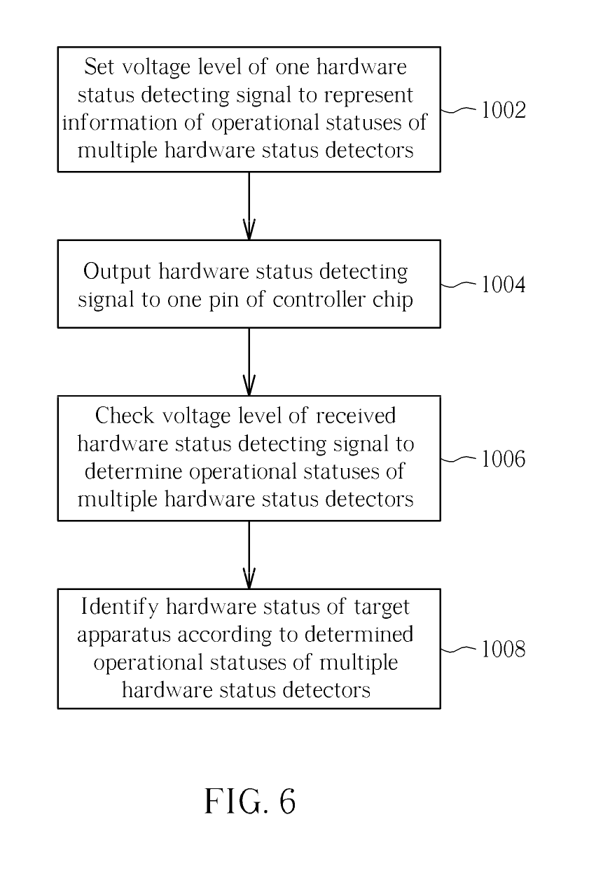

FIG. 6 is a flowchart illustrating the operation of the hardware status detecting system 100 with the hardware status detecting circuit 102 implemented using one of the exemplary circuit configurations shown in FIG. 2, FIG. 4, and FIG. 5. Provided that the result is substantially the same, the steps are not required to be executed in the exact order shown in FIG. 6. The hardware status detecting and identifying operation includes following steps.

Step 1002: Set a voltage level of one hardware status detecting signal to represent information of operational statuses of multiple hardware status detectors which operate in response to a hardware status of a target apparatus.

Step 1004: Output the hardware status detecting signal to one pin of a controller chip.

Step 1006: Check the voltage level of the hardware status detecting signal received by the pin to determine the operational statuses of multiple hardware status detectors.

Step 1008: Identify the hardware status of the target apparatus according to the determined operational statuses of multiple hardware status detectors.

As a person skilled in the art can readily understand details of the steps in FIG. 6 after reading above paragraphs, further description is omitted here for brevity.

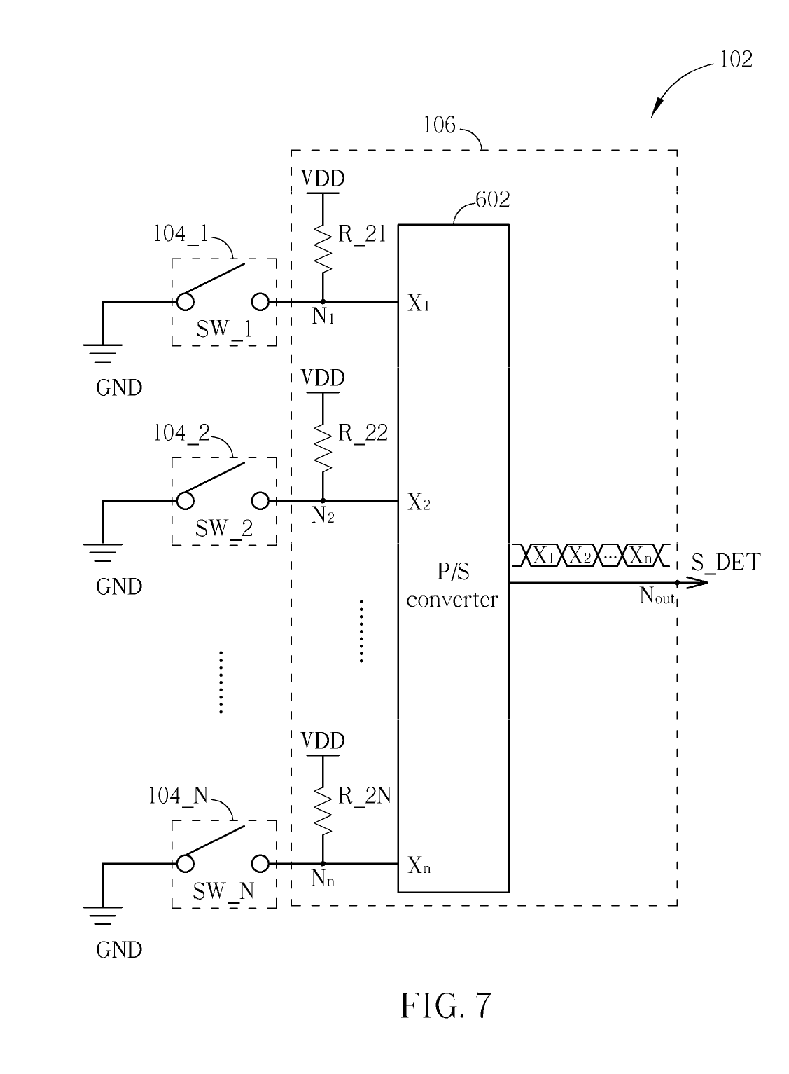

Please refer to FIG. 7, which is a second exemplary implementation of the hardware status detecting circuit 102 shown in FIG. 1. The signal processing unit 106 has a plurality of input nodes N₁-Nₙ and a single output node Nₒᵤₜ utilized for outputting the hardware status detecting signal S_DET. In this exemplary embodiment, the hardware status detectors 104_1-104_N are implemented with switches SW_1-SW_N respectively coupled to the input nodes N₁-Nₙ. Specifically, each of the switches SW_1-SW_N is coupled between a first reference voltage (e.g., the ground voltage GND) and one of the input nodes N₁-Nₙ. As shown in FIG. 7, the signal processing unit 106 includes a plurality of resistive elements R_21-R_2N respectively coupled to the input nodes N₁-Nₙ, and a parallel-to-serial (P/S) converter 602 coupled to the input nodes N₁-Nₙ for generating the hardware status detecting signal S_DET, which is a bit stream in this exemplary embodiment, to the single output node Nₒᵤₜ.

As can be seen from FIG. 7, each of the resistive elements R_21-R_2N is coupled between a second reference voltage (e.g., the supply voltage VDD) and one of the input nodes N₁-Nₙ. Due to the use of the parallel-to-serial converter 602, the signal processing unit 106 shown in FIG. 7 therefore generates the hardware status detecting signal S_DET by sequentially outputting the information of the operational statuses of the hardware status detectors 104_1-104_N (i.e., the on/off statuses of the switches SW_1-SW_N). In other words, the data bits X₁-X_{N} simultaneously received by the parallel-to-serial converter 602 will be outputted one by one, resulting in a single bit stream delivered to the pin 109 of the controller chip 108 shown in FIG. 1. The signal processing logic 112 may be implemented by a decoder which determines the operational statuses of the hardware status detectors 104_1-104_N by checking/decoding the data bits sequentially transmitted by the hardware status detecting signal S_DET. After the operational statuses of the hardware status detectors 104_1-104_N are determined, the hardware status of the target apparatus can be easily identified by the hardware status identifying logic 114.

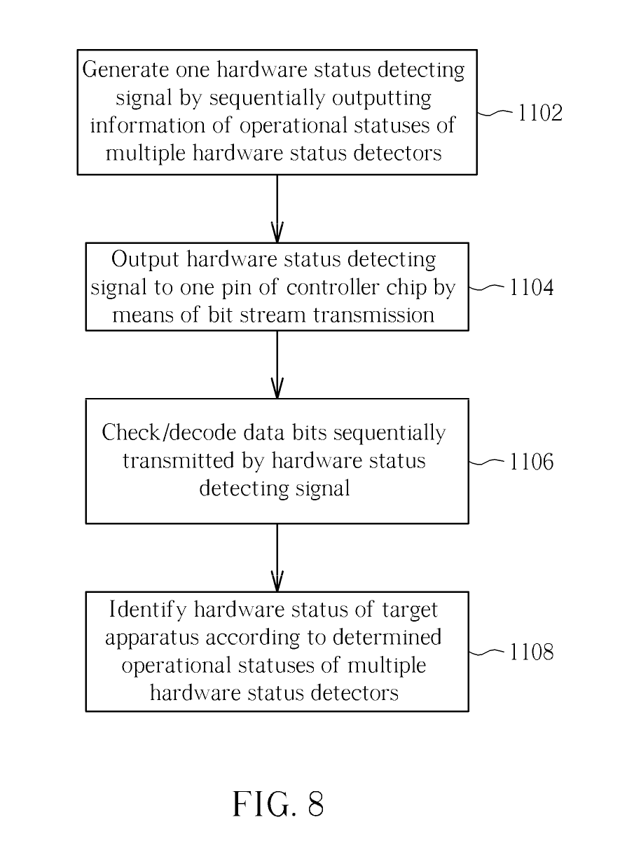

FIG. 8 is a flowchart illustrating the operation of the hardware status detecting system 100 with the hardware status detecting circuit 102 implemented by the exemplary circuit configuration shown in FIG. 7. Provided that the result is substantially the same, the steps are not required to be executed in the exact order shown in FIG. 8. The hardware status detecting and identifying operation includes following steps.

Step 1102: Generate one hardware status detecting signal by sequentially outputting information of operational statuses of multiple hardware status detectors which operate in response to a hardware status of a target apparatus.

Step 1104: Output the hardware status detecting signal to one pin of a controller chip by means of bit stream transmission.

Step 1106: Check/decode data bits sequentially transmitted by the hardware status detecting signal received by the pin to determine the operational statuses of multiple hardware status detectors.

Step 1108: Identify the hardware status of the target apparatus according to the determined operational statuses of multiple hardware status detectors.

As a person skilled in the art can readily understand details of the steps in FIG. 8 after reading above paragraphs, further description is omitted here for brevity.

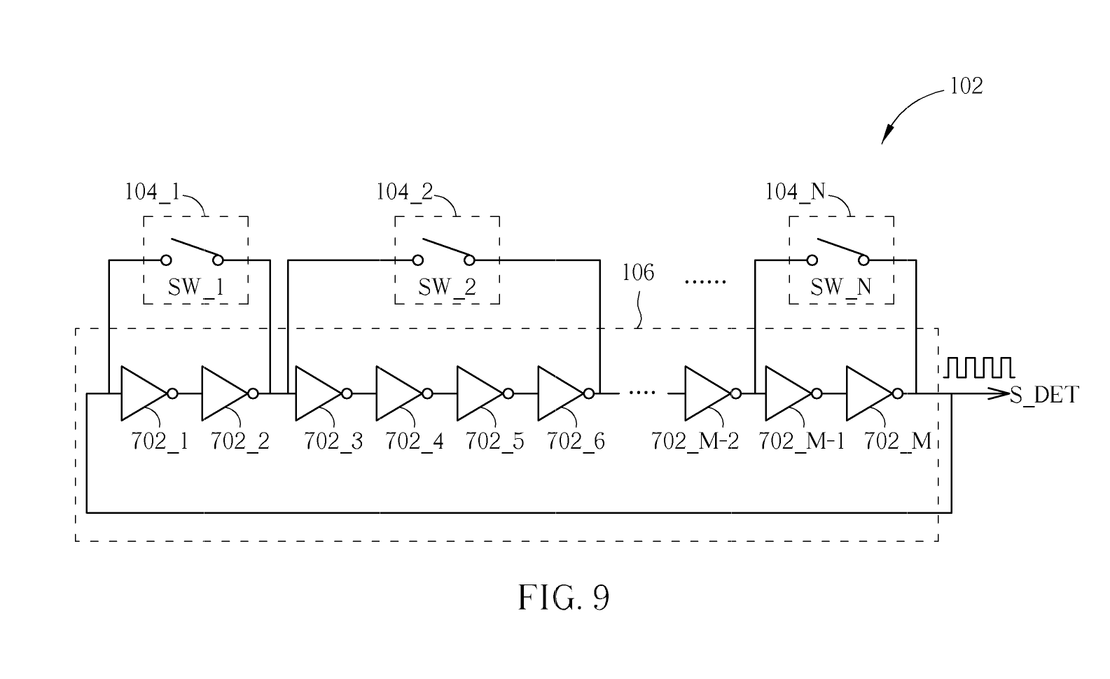

Please refer to FIG. 9, which is a third exemplary implementation of the hardware status detecting circuit 102 shown in FIG. 1. In this exemplary embodiment, the signal processing unit 106 is implemented with a ring oscillator having a plurality of inverters 702_1-702_M, and the hardware status detectors 104_1-104_N are implemented with switches SW_1-SW_N each coupled to at least one of the inverters 702_1-702_M for controlling that how many inverters are bypassed. For example, when the switch SW_1 is switched on, the inverters 702_1 and 702_2 are bypassed and the oscillating frequency of the ring oscillator is changed accordingly. Similarly, each of the switches SW_2-SW_N also has the capability of adjusting the oscillating frequency of the ring oscillator. In other words, the on/off statuses of the switches SW_1-SW_N dominate the final oscillating frequency of the ring oscillator (i.e., the frequency of the hardware status detecting signal S_DET). Thus, the signal processing unit 106 shown in FIG. 9 serves as a switch-to-clock converter and sets a frequency/clock rate of the hardware status detecting signal S_DET to represent the information of the operational statuses of the hardware status detectors 104_1-104_N (i.e., the on/off statuses of the switches SW_1-SW_N), where different frequencies of the hardware status detecting signal S_DET correspond to different combinations of the operational statuses of the hardware status detectors, respectively. The signal processing logic 112 shown in FIG. 1 therefore may be implemented by a frequency detector which determines the operational statuses of the hardware status detectors 104_1-104_N by detecting the frequency of the hardware status detecting signal S_DET. After the operational statuses of the hardware status detectors 104_1-104_N are determined, the hardware status of the target apparatus can be easily identified by the hardware status identifying logic 114.

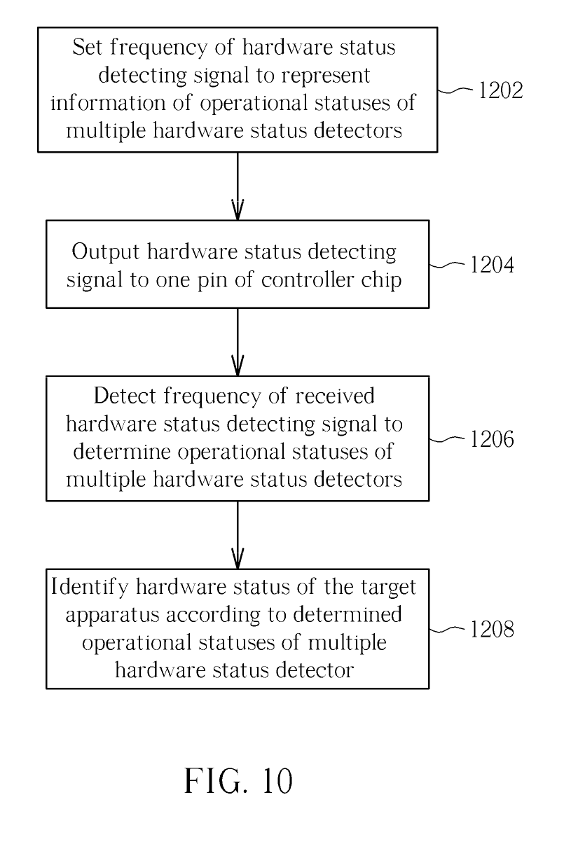

FIG. 10 is a flowchart illustrating the operation of the hardware status detecting system 100 with the hardware status detecting circuit 102 implemented with the exemplary circuit configuration shown in FIG. 9. Provided that the result is substantially the same, the steps are not required to be executed in the exact order shown in FIG. 10. The hardware status detecting and identifying operation includes following steps.

Step 1202: Set a frequency of one hardware status detecting signal to represent information of operational statuses of multiple hardware status detectors, wherein the hardware status detectors operate in response to a hardware status of a target apparatus.

Step 1204: Output the hardware status detecting signal to one pin of a controller chip.

Step 1206: Detect the frequency of the hardware status detecting signal received by the pin to determine the operational statuses of multiple hardware status detectors.

Step 1208: Identify the hardware status of the target apparatus according to the determined operational statuses of multiple hardware status detectors.

As a person skilled in the art can readily understand details of the steps in FIG. 10 after reading above paragraphs, further description is omitted here for brevity.

When the aforementioned target apparatus, such as a slot-in type optical disc drive, enters a sleep/standby mode, the internal clock sources may be powered down to save power. Therefore, provided that the signal processing logic 112 shown in FIG. 1 operates according to a clock signal, the signal processing logic 112 may be unable to sample the hardware status detecting signal S_DET for detecting the voltage level of the hardware status detecting signal S_DET. Therefore, the pin 109 is shared between a first mode and a second mode. Specifically, the hardware status identifying logic 114 identifies the hardware status of the target apparatus according to the operational statuses of the hardware status detectors 104_1-104_N when operating under the first mode (e.g., a normal mode), wherein the operational statuses are determined by the signal processing logic 112.

Moreover, the hardware status identifying logic 114 identifies the hardware status of the target apparatus by a level change of the hardware status detecting signal S_DET when operating under the second mode (e.g., a sleep/standby mode). For example, if an optical disc is disposed at the entrance of the optical disc drive to have a contact with at least one of the aforementioned switches (e.g., SW_1-SW_N in FIG. 2, SW_1-SW_N in FIG. 4, or SW_1′-SW_N′ in FIG. 5) after a slot-in type optical disc drive enters the sleep/standby mode, the triggered hardware status detecting signal S_DET will have a voltage level change due to such a wake-up event (i.e., insertion of the optical disc). The hardware status identifying logic 114 therefore detects the occurrence of the wake-up event by identifying the voltage level change of the hardware status detecting signal S_DET. Next, the slot-in type optical disc drive leaves the sleep/standby mode and enters the normal mode, and the signal processing logic 112 works normally and the hardware status identifying logic 114 identifies the disc loading/unloading status of the slot-in type optical disc drive according to the processing result of the signal processing logic 112.

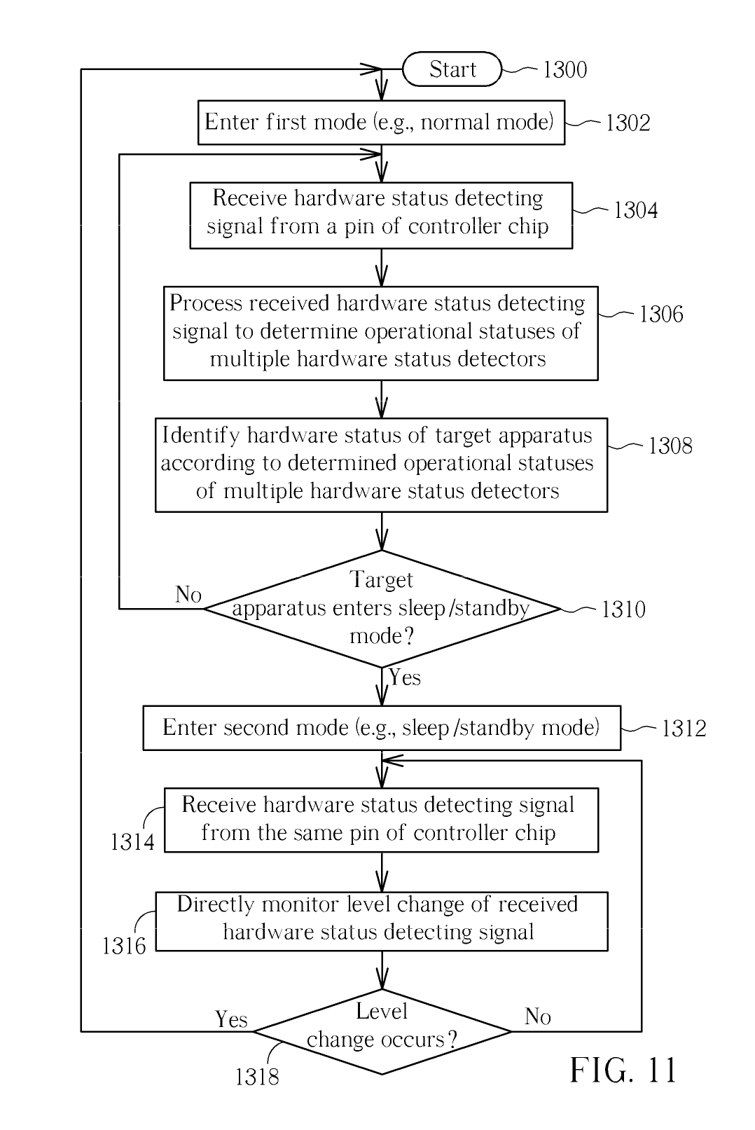

FIG. 11 is a flowchart illustrating the operation of the hardware status identifying circuit 110 shown in FIG. 1. Provided that the result is substantially the same, the steps are not required to be executed in the exact order shown in FIG. 11. The hardware status identifying operation performed by the hardware status identifying circuit 110 includes following steps.

Step 1300: Start.

Step 1302: Enter a first mode (e.g., a normal mode).

Step 1304: Receive a hardware status detecting signal from a pin of a controller chip under the first mode, where the hardware status detecting signal carries information of operational statuses of multiple hardware status which operate in response to a hardware status of a target apparatus.

Step 1306: Process the hardware status detecting signal to determine the operational statuses of multiple hardware status detectors.

Step 1308: Identify the hardware status of the target apparatus according to the determined operational statuses of multiple hardware status detectors.

Step 1310: Does the target apparatus enter a sleep/standby mode? If yes, go to step 1312; otherwise, go to step 1304.

Step 1312: Enter a second mode (e.g., the sleep/standby mode).

Step 1314: Receive a hardware status detecting signal from the pin of the controller chip under the second mode.

Step 1316: Directly monitor a level change of the hardware status detecting signal to determine whether the hardware status detecting signal is triggered by a particular event (e.g., a wake-up event).

Step 1318: Check if the level change of the hardware status detecting signal occurs (i.e., check if the hardware status detecting signal is triggered). If yes, go to step 1302; otherwise, go to step 1314.

As a person skilled in the art can readily understand details of the steps in FIG. 11 after reading above paragraphs, further description is omitted here for brevity.

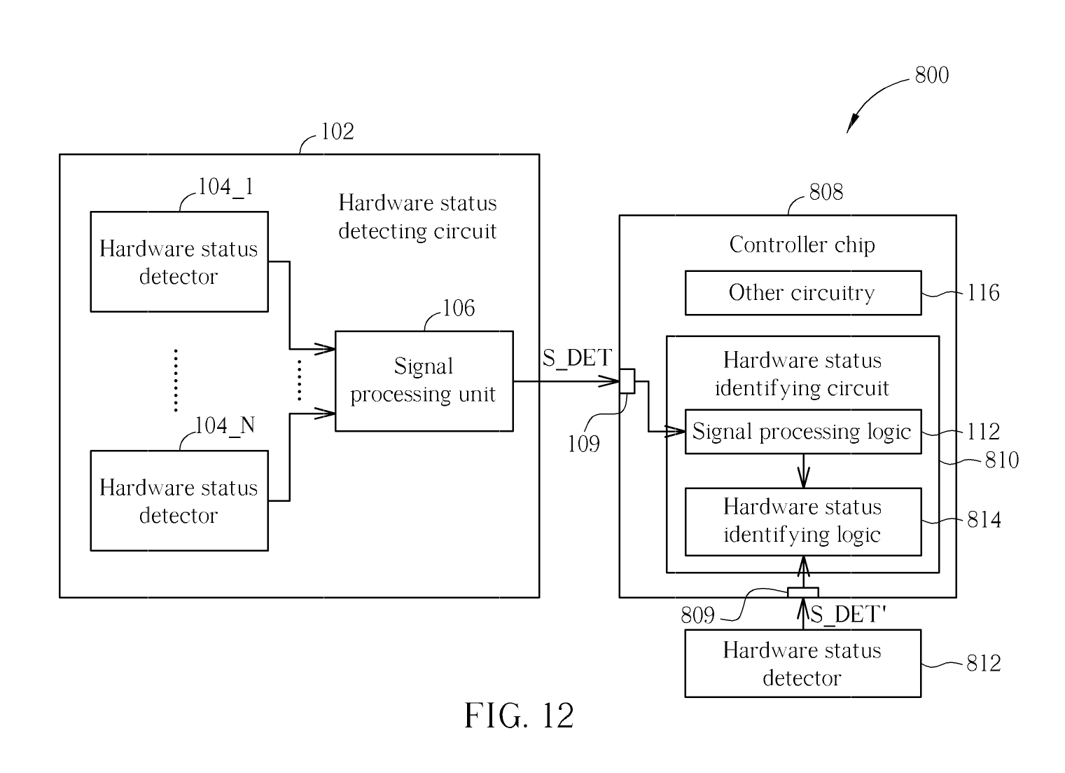

As mentioned above, the pin 109 is shared between the normal mode and the sleep/standby mode, and the hardware status detecting signal S_DET received by the pin 109 under the sleep/standby mode can serve as a wake-up signal. In an alternative design, the wake-up signal can be generated independently. Please refer to FIG. 12, which is a block diagram illustrating a hardware status processing system according to a second exemplary embodiment of the present invention. The exemplary hardware status detecting system 800 is similar to the exemplary hardware status detecting system 100 shown in FIG. 1. The major different is that the hardware status detecting system 800 has a hardware status detector 812 coupled to a pin 809 of the controller chip 808, and the hardware status identifying logic 814 receives another hardware status detecting signal S_DET′ generated from the hardware status detector 812. It is noted that the hardware status detectors 104_1-104_N can be seen as a plurality of first hardware status detectors, and the hardware status detector 812 can be seen as a second hardware status detector.

In the above exemplary embodiment, the hardware status detecting circuit 102 may be implemented with one of the aforementioned exemplary circuit configurations shown in FIG. 2, FIG. 4, FIG. 5, FIG. 7, and FIG. 9, and the signal processing logic 112 should be configured to perform a proper signal processing operation corresponding to the circuit configuration employed by the hardware status detecting circuit 102. Further description is omitted here for brevity.

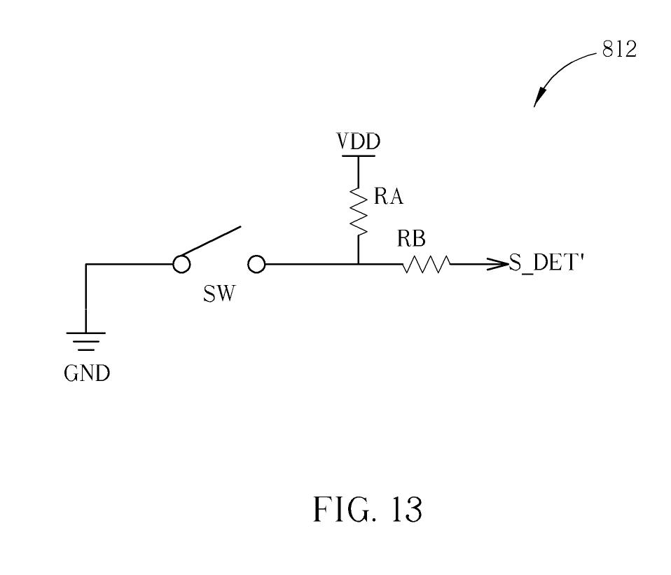

Regarding the hardware status detector 812, it operates in response to the hardware status of the target apparatus and accordingly generates the hardware status detecting signal S_DET′. FIG. 13 is a diagram illustrating an exemplary implementation of the hardware status detector 812 shown in FIG. 12. As shown in the figure, the hardware status detector 812 includes a switch SW and a plurality of resistive elements RA and RB. When the target apparatus is a slot-in type optical disc drive, the switch SW may be disposed at a position closest to the entrance of the slot-in type optical disc drive, as compared with remaining switches used in the hardware status detecting circuit 102. Thus, the switch SW is capable of detecting the wake-up event caused by an optical disc inserted to the entrance of the slot-in type optical disc drive when the slot-in type optical disc drive is in the sleep/standby mode. To put it simply, the hardware status identifying logic 814 identifies the hardware status of the target apparatus according to the operational statuses of the hardware status detectors 104_1-104_N when operating under a first mode (e.g., the normal mode), wherein the operational statuses are determined by the signal processing logic 112. Moreover, the hardware status identifying logic 814 identifies the hardware status of the target apparatus by directly monitoring a voltage level change of the hardware status detecting signal S_DET′ when operating under a second mode (e.g., the sleep/standby mode).

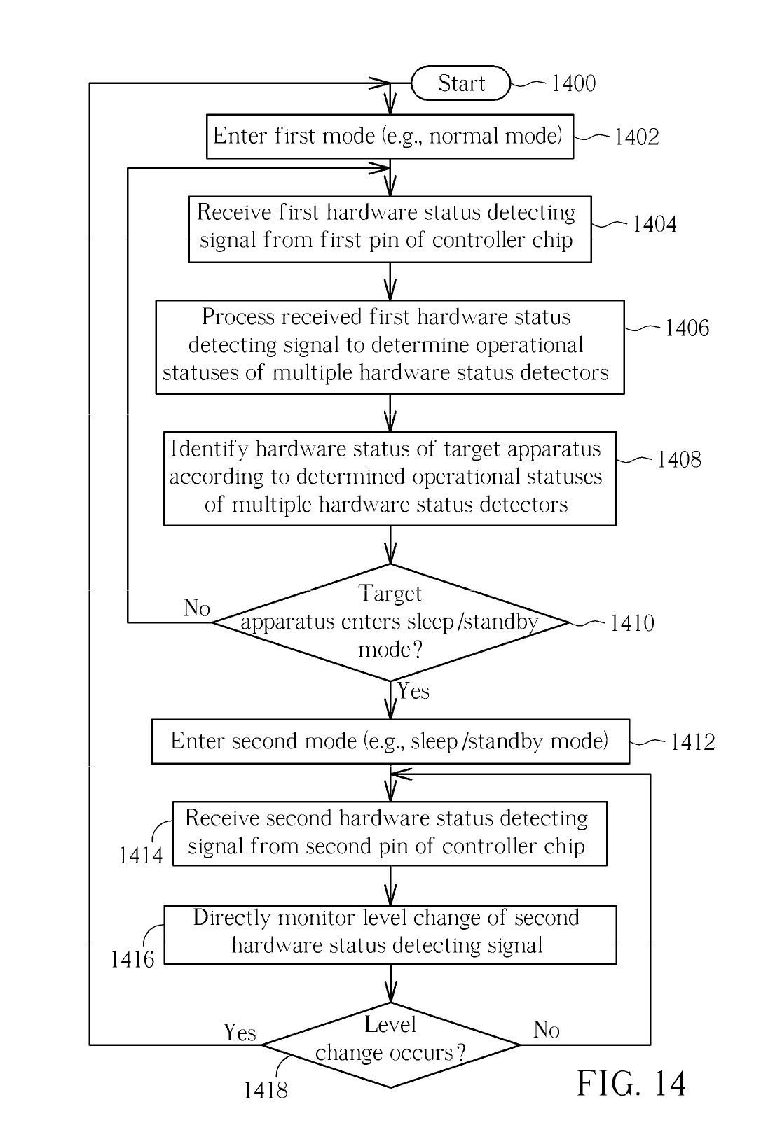

FIG. 14 is a flowchart illustrating the operation of the hardware status identifying circuit 810 shown in FIG. 12. Provided that the result is substantially the same, the steps are not required to be executed in the exact order shown in FIG. 14. The hardware status identifying operation performed by the hardware status identifying circuit 810 includes following steps.

Step 1400: Start.

Step 1402: Enter a first mode (e.g., a normal mode).

Step 1404: Receive a first hardware status detecting signal (e.g., the aforementioned hardware status detecting signal S_DET) from a first pin of a controller chip under the first mode, where the first hardware status detecting signal carries information of operational statuses of multiple hardware status which operate in response to a hardware status of a target apparatus.

Step 1406: Process the first hardware status detecting signal to determine the operational statuses of multiple hardware status detectors.

Step 1408: Identify the hardware status of the target apparatus according to the determined operational statuses of multiple hardware status detectors.

Step 1410: Does the target apparatus enters a sleep/standby mode? If yes, go to step 1412; otherwise, go to step 1404.

Step 1412: Enter a second mode (e.g., the sleep/standby mode).

Step 1414: Receive a second hardware status detecting signal (e.g., the aforementioned hardware status detecting signal S_DET′) from a second pin of the controller chip under the second mode.

Step 1416: Directly monitor a level change of the second hardware status detecting signal.

Step 1418: Check if the level change of the second hardware status detecting signal occurs. If yes, go to step 1402; otherwise, go to step 1414.

As a person skilled in the art can readily understand details of the steps in FIG. 14 after reading above paragraphs, further description is omitted here for brevity.

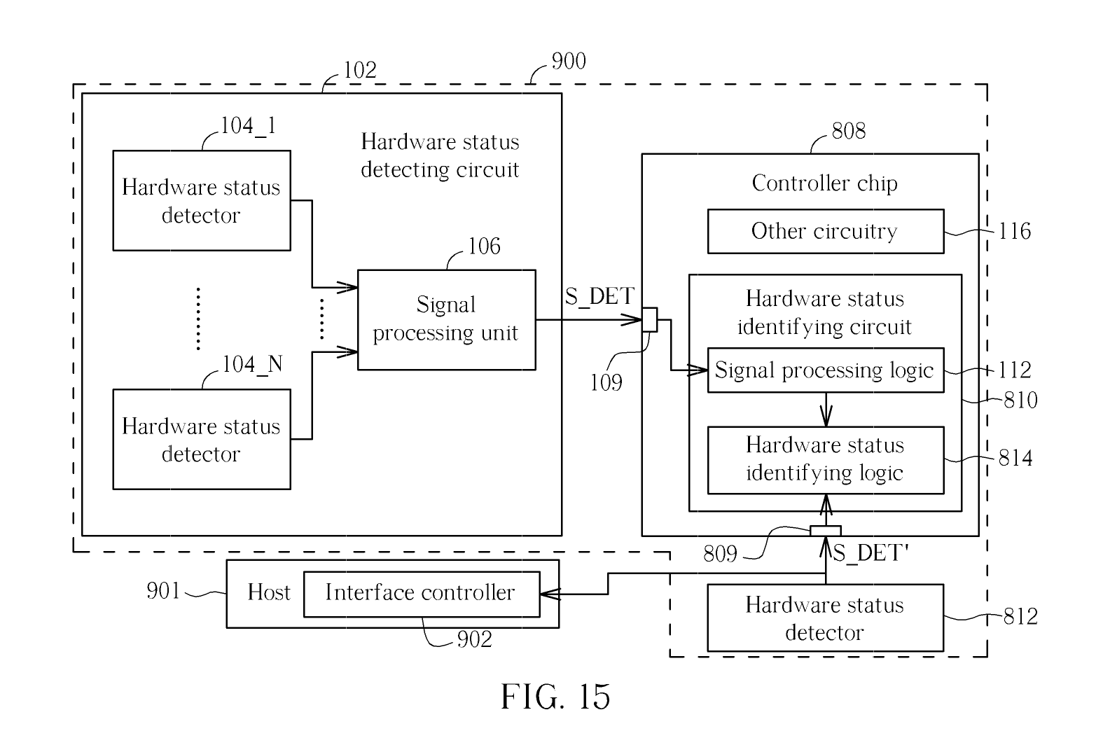

FIG. 15 is a block diagram illustrating a hardware status processing system according to a third exemplary embodiment of the present invention. The exemplary hardware status detecting system 900 is similar to the exemplary hardware status detecting system 800 shown in FIG. 12. The major different is that the target apparatus communicates with a host 901 via an interface (e.g., a serial advanced technology attachment (SATA) interface) which is controlled by an interface controller 902, and the hardware status detector 812 further transmits the hardware status detecting signal S_DET′ to the interface controller 901. For example, when a wake-up event is detected by the hardware status detector 812, the interface controller 902 is also notified by the hardware status detecting signal S_DET′.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A hardware status detecting circuit for detecting a hardware status of a target apparatus, comprising:
a plurality of hardware status detectors, operating in response to the hardware status of the target apparatus; and
a signal processing unit, coupled to the hardware status detectors, for generating a hardware status detecting signal having information of operational statuses of the hardware status detectors embedded therein.

2. The hardware status detecting circuit of claim 1, wherein the signal processing unit sets a voltage level of the hardware status detecting signal to represent the information of the operational statuses of the hardware status detectors, and different voltage levels of the hardware status detecting signal correspond to different combinations of the operational statuses of the hardware status detectors, respectively.

3. The hardware status detecting circuit of claim 2, wherein the signal processing unit has a plurality of input nodes and a single output node utilized for outputting the hardware status detecting signal; the hardware status detectors are switches respectively coupled to the input nodes; each of the switches is coupled between a first reference voltage and a second reference voltage through a plurality of resistive element respectively.

4. The hardware status detecting circuit of claim 2, wherein the signal processing unit has a plurality of input nodes and a single output node utilized for outputting the hardware status detecting signal; the hardware status detectors are switches respectively coupled to the input nodes; each of the switches is coupled between a first reference voltage and the single output node through a plurality of first resistive element respectively, and a second resistive element is coupled between the single output node and a second reference voltage.

5. The hardware status detecting circuit of claim 2, wherein the signal processing unit has a plurality of input nodes and a single output node utilized for outputting the hardware status detecting signal; the hardware status detectors are switches respectively coupled to the input nodes; each of the switches has a first input end coupled to a first reference voltage, a second input end coupled to a second reference voltage, and an output end coupled to one of the input nodes, where the output end is selectively coupled to the first input end or the second input end.

6. The hardware status detecting circuit of claim 1, wherein the signal processing unit generates the hardware status detecting signal by sequentially outputting the information of the operational statuses of the hardware status detectors.

7. The hardware status detecting circuit of claim 6, wherein the signal processing unit has a plurality of input nodes and a single output node utilized for outputting the hardware status detecting signal; the hardware status detectors are switches respectively coupled to the input nodes; each of the switches is coupled between a first reference voltage and a second reference voltage through a plurality of resistive elements respectively, and a parallel-to-serial converter is coupled to the input nodes for generating the hardware status detecting signal to the single output node.

8. The hardware status detecting circuit of claim 1, wherein the signal processing unit sets a frequency of the hardware status detecting signal to represent the information of the operational statuses of the hardware status detectors, and different frequencies of the hardware status detecting signal correspond to different combinations of the operational statuses of the hardware status detectors, respectively.

9. The hardware status detecting circuit of claim 8, wherein the signal processing unit is a ring oscillator having a plurality of inverters, and the hardware status detectors are switches each coupled to at least one inverter of the inverters for controlling whether the at least one inverter is bypassed.

10. The hardware status detecting circuit of claim 1, wherein the target apparatus is an optical storage apparatus having the hardware status detecting circuit employed therein.

11. A hardware status identifying circuit for identifying a hardware status of a target apparatus, comprising:
a signal processing logic, for receiving a first hardware status detecting signal, and determining operational statuses of a plurality of first hardware status detectors by processing the first hardware status detecting signal; and
a hardware status identifying logic, coupled to the signal processing logic, for identifying the hardware status of the target apparatus according to the determined operational statuses of the first hardware status detectors.

12. The hardware status identifying circuit of claim 11, wherein the signal processing logic determines the operational statuses of the first hardware status detectors by checking a voltage level of the first hardware status detecting signal, where different voltage levels of the hardware status detecting signal correspond to different combinations of the operational statuses of the first hardware status detectors, respectively.

13. The hardware status identifying circuit of claim 11, wherein the signal processing logic determines the operational statuses of the first hardware status detectors by checking data bits sequentially transmitted by the first hardware status detecting signal.

14. The hardware status identifying circuit of claim 11, wherein the signal processing logic determines the operational statuses of the first hardware status detectors by detecting a frequency of the first hardware status detecting signal, where different frequencies of the hardware status detecting signal correspond to different combinations of the operational statuses of the first hardware status detectors, respectively.

15. The hardware status identifying circuit of claim 11, wherein the hardware status identifying logic identifies the hardware status of the target apparatus according to the determined operational statuses of the first hardware status detectors when operating under a first mode; and the hardware status identifying logic identifies the hardware status of the target apparatus by directly monitoring a level change of the first hardware status detecting signal when operating under a second mode.

16. The hardware status identifying circuit of claim 15, wherein when the hardware status identifying circuit enters a sleep/standby mode, the hardware status identifying logic leaves the first mode and enters the second mode.

17. The hardware status identifying circuit of claim 11, wherein the hardware status identifying logic identifies the hardware status of the target apparatus according to the determined operational statuses of the first hardware status detectors when operating under a first mode; and the hardware status identifying logic further receives a second hardware status detecting signal generated from a second hardware status detector, and identifies the hardware status of the target apparatus by directly monitoring a level change of the second hardware status detecting signal when operating under a second mode.

18. The hardware status identifying circuit of claim 17, wherein when the hardware status identifying circuit enters a sleep/standby mode, the hardware status identifying logic leaves the first mode and enters the second mode.

19. The hardware status identifying circuit of claim 11, wherein the target apparatus is an optical storage apparatus having the hardware status identifying circuit employed therein.

20. A hardware status processing system, comprising:
a hardware status detecting circuit for detecting a hardware status of a target apparatus, comprising:
a plurality of first hardware status detectors, operating in response to the hardware status of the target apparatus; and
a signal processing unit, coupled to the first hardware status detectors, for generating a first hardware status detecting signal having information of operational statuses of the first hardware status detectors embedded therein; and
a controller chip, comprising:
a first pin, coupled to the hardware status detecting circuit, for receiving the first hardware status detecting signal; and
a hardware status identifying circuit for identifying the hardware status of the target apparatus, comprising:
a signal processing logic, for determining the operational statuses of the first hardware status detectors by processing the first hardware status detecting signal received by the first pin; and
a hardware status identifying logic, coupled to the signal processing logic, for identifying the hardware status of the target apparatus according to the determined operational statuses of the first hardware status detectors.

21. The hardware status processing system of claim 20, wherein the hardware status identifying logic identifies the hardware status of the target apparatus according to the determined operational statuses of the first hardware status detectors when operating under a first mode; and the hardware status identifying logic identifies the hardware status of the target apparatus by directly monitoring a level change of the first hardware status detecting signal when operating under a second mode.

22. The hardware status processing system of claim 21, wherein when the hardware status identifying circuit enters a sleep/standby mode, the hardware status identifying logic leaves the first mode and enters the second mode.

23. The hardware status processing system of claim 20, further comprising:
a second hardware status detector operating in response to the hardware status of the target apparatus and accordingly generating a second hardware status detecting signal;
wherein the controller chip further comprises a second pin, coupled to the second hardware status detecting circuit, for receiving the second hardware status detecting signal; the hardware status identifying logic identifies the hardware status of the target apparatus according to the determined operational statuses of the first hardware status detectors when operating under a first mode; and the hardware status identifying logic identifies the hardware status of the target apparatus by directly monitoring a level change of the second hardware status detecting signal when operating under a second mode.

24. The hardware status processing system of claim 23, wherein when the hardware status identifying circuit enters a sleep/standby mode, the hardware status identifying logic leaves the first mode and enters the second mode.

25. The hardware status processing system of claim 23, wherein the target apparatus communicates with a host via an interface which is controlled by an interface controller, and the second hardware status detector further transmits the second hardware status detecting signal to the interface controller.

26. The hardware status processing system of claim 20, wherein the target apparatus is an optical storage apparatus having the hardware status processing system employed therein.

27. A method for detecting a hardware status of a target apparatus, comprising:
utilizing a plurality of hardware status detectors which operate in response to the hardware status of the target apparatus; and
generating a hardware status detecting signal having information of operational statuses of the hardware status detectors embedded therein.

28. A method for identifying a hardware status of a target apparatus, comprising:
receiving a hardware status detecting signal, and determining operational statuses of a plurality of first hardware status detectors by processing the hardware status detecting signal; and
identifying the hardware status of the target apparatus according to the determined operational statuses of the first hardware status detectors.
